(19) United States
(12) Patent Application Publication
(10) Pub. No.: US 2007/0147817 A1
(43) Pub. Date: Jun. 28, 2007

(54) Camera feature with divided autofocus search range

(76) Inventors: Jingqiang Li, San Diego, CA (US); Ying Xie Noyes, San Diego, CA (US); Chinchuan Andrew Chiu, San Diego, CA (US)

Correspondence Address: QUALCOMM INCORPORATED, 5775 MOREHOUSE DR., SAN DIEGO, CA, 92121, US

(21) Appl. No.: 11/471,056

(22) Filed: Jun. 19, 2006

Related U.S. Application Data
(60) Provisional application No. 60/722,882, filed on Sep. 29, 2005.

(51) Int. Cl. G03B 3/10

(52) U.S. Cl. 396/133

(57) ABSTRACT

Apparatus are provided, including an autofocus mechanism. The autofocus mechanism includes an autofocus preliminary operation mechanism and an autofocus continuation mechanism. The autofocus preliminary operation mechanism starts an autofocus of a lens assembly on a given target by causing a focus quality determiner to determine the quality of focus of the lens assembly on the given target while the position of the lens unit is in one focus range and causing an adjustment controller to effect a preliminary adjustment of the lens assembly position within the same one focus range. The autofocus continuation mechanism automatically, upon a lack of successful focus by the autofocus preliminary operation mechanism, continues an autofocus of the lens assembly on the given target by causing the adjustment controller to effect a continued adjustment of the lens assembly position from the one focus range to a different focus range while the focus quality determiner continues to determine the quality of the focus.

### COPYRIGHT NOTICE

This application claims the benefit of provisional U.S. Application Ser. No. 60/722,882, entitled “SOFT BOUNDARY FOR DIVIDED AUTOFOCUS SEARCHING RANGE,” filed Sep. 29, 2005, assigned to the assignee of the present application, and incorporated herein by reference in its entirety for all purposes.

This patent document contains information subject to copyright protection. The copyright owner has no objection to the facsimile reproduction by anyone of the patent document or the patent, as it appears in the US Patent and Trademark Office files or records, but otherwise reserves all copyright rights whatsoever.

### FIELD OF THE DISCLOSURE

Aspects of the present disclosure relate to devices with camera features, including a divided autofocus search range.

### BACKGROUND

Cameras or other devices with camera features include point-and-shoot digital or analog camera elements. A desired feature in these devices is the ability to switch the device from a “normal mode” (for focusing to objects located from a moderate distance from the camera to infinity) to a “macro mode” (for focusing to objects that are close to the camera, for example, as close as a few or several centimeters away). Many such devices have both a regular mode and a macro mode for auto focusing, so that the camera can automatically search within the selected focus mode. By limiting the focus search to the selected focus mode, focusing time can be saved. In addition, battery power can be saved, and the wear and tear on the lens positioning motor can be minimized.

Among cameras or devices with both regular and macro modes for autofocusing, if the user selects the wrong mode, it may not be possible for the camera to focus on the selected target object.

### SUMMARY OF THE DISCLOSURE

In accordance with one aspect of the present disclosure, apparatus are provided. The apparatus include an autofocus mechanism. The autofocus mechanism includes an autofocus preliminary operation mechanism and an autofocus continuation mechanism. The autofocus preliminary operation mechanism starts an autofocus of a lens assembly on a given target by first causing a focus quality determiner to determine the quality of focus of the lens assembly on the given target while the position of the lens unit is in one focus range. The autofocus of the lens assembly on the given target is started by causing an adjustment controller to effect a preliminary adjustment of the lens assembly position, within the same one focus range. The autofocus continuation mechanism automatically, upon a lack of successful focus by the autofocus preliminary operation mechanism while the lens assembly position is in the one focus range, continues an autofocus of the lens assembly on the given target by causing the adjustment controller to effect a continued adjustment of the lens assembly position from the one focus range to a different focus range. Meanwhile, the focus quality determiner continues to determine the quality of the focus.

### BRIEF DESCRIPTION OF THE DRAWINGS

Embodiments of the present disclosure are described in the detailed description which follows by reference to the noted drawings, by way of non-limiting example embodiments, in which like reference numerals represents similar parts throughout the several views of the drawings, and wherein:

FIG. 1 is a block diagram of an embedded device including one embodiment of a camera feature;

FIG. 2 is a schematic diagram of a user interface of the illustrated embedded device;

FIG. 3 is a flow chart of an autofocus process; and

FIG. 4 shows a graph illustrating focus value curves.

### DETAILED DESCRIPTION

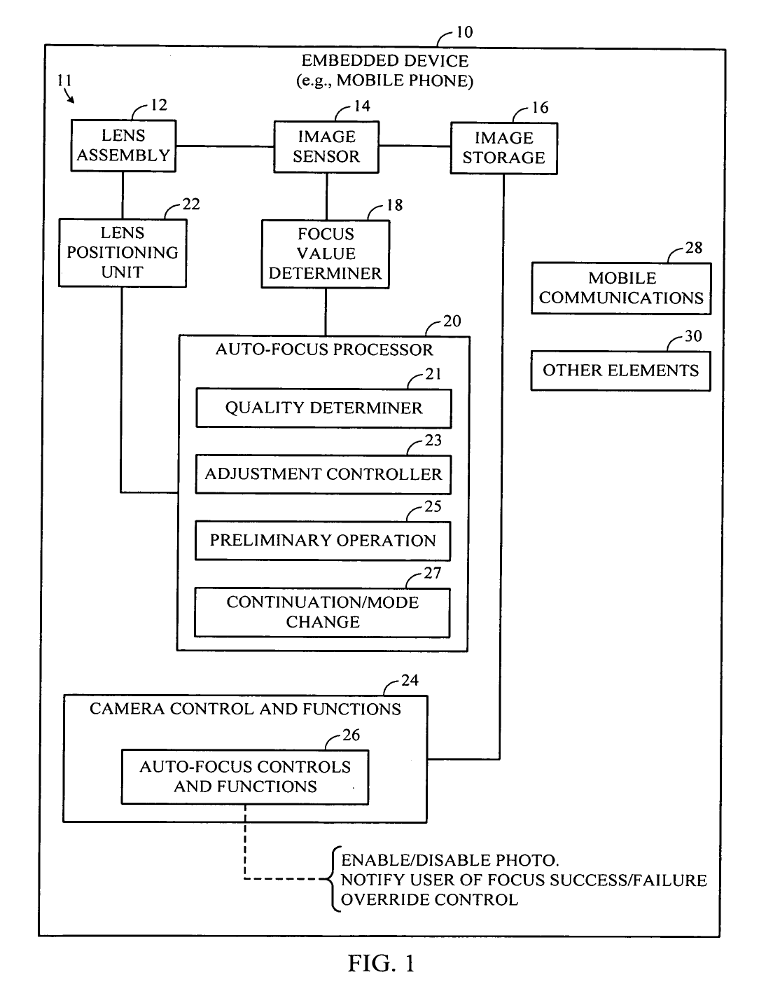

FIG. 1 is a block diagram of an embedded device 10. The illustrated embedded device 10 may include, for example, a mobile communications device with a camera feature. The mobile communications device may, for example, be a mobile phone.

The illustrated embedded device 10 includes a camera portion 11, mobile communications circuitry 28, and other elements 30. The camera portion 11 includes a lens assembly 12, an image sensor 14, image storage 16, and a camera control and functions unit 24. In addition, the camera portion 11 includes a lens positioning unit 22, a focus value determiner 18, and an autofocus processor 20.

The lens assembly 12 may include a lens assembly for allowing the taking of pictures, including both zoom and focus mechanisms. Image sensor 14 may include, for example, film, in the case of an analog camera, or a digital image sensor, for example, a CCD device (charged-coupled device). Image storage 16 may include local RAM (random access memory) memory provided within embedded device 10, and/or a removable memory device, for example, a memory card or a disk.

Focus value determiner 18 may include, for example, software or circuitry for calculating a focus value based upon a signal produced by image sensor 14.

Autofocus processor 20 causes the adjustment of the lens assembly positioning by sending a signal to lens positioning unit 22, to obtain a desired focus of the image as received by image sensor 14. Specifically, autofocus processor 20 may include a focus quality determiner 21 to determine a quality of focus of the lens assembly 12 on a given target, and an adjustment controller 23 to interact with lens positioning unit 22 to effect adjustment of the positioning of the lens assembly toward an improved quality of focus of the lens assembly 12 on the given target.

Camera control and functions units 24 may include, for example, various control and user interaction features, for example, switches, an image display, a display for displaying to users various icons and camera function controls, and mechanisms to receive inputs and cause the resulting adjustment of various settings and controls of the camera portion. Camera controls and functions unit 24 may be provided with an autofocus controls and functions unit 26. Autofocus controls and functions unit 26 may, for example, include mechanisms to cause certain actions when an autofocus attempt by autofocus processor 20 is successful or when an attempt is not (yet) successful or when an attempt fails. For example, when an autofocus is successful, a photograph function of the camera portion may be enabled. Instead, when the autofocus is not successful, the photograph function may be disabled. In addition, the user may be notified when the autofocus attempt was either successful or a failure. In addition, a mechanism may be provided to allow a user to override the focus control by autofocus processor 20, to allow the user to control the focus of the camera portion, and thus the positioning of lens assembly 12.

An autofocus attempt is successful when certain autofocus criteria are met, while an autofocus attempt is not successful when the autofocus criteria are not met.

Autofocus processor 22 may further include a preliminary operation mechanism 25 and a continuation mechanism 27 (which may include a focus mode changing mechanism). The preliminary operation mechanism 25 starts an autofocus of a lens assembly on a given target by first causing a focus quality determiner to determine the quality of focus of the lens assembly on the given target while the position of the lens unit is in one focus range (e.g., the current focus range; in the illustrated embodiment, the current focus range is one of a macro range and a normal range). In addition, the autofocus of the lens assembly on the given target is started by also causing an adjustment controller to effect a preliminary adjustment of the lens assembly position by the lens positioning unit 22, within the same one focus range.

The continuation mechanism 27 automatically, upon a lack of successful focus by the preliminary operation mechanism 25 while the lens assembly position is in the one focus range, continues an autofocus of the lens assembly on the given target, by causing the adjustment controller (the lens positioning unit 22 in the illustrated embodiment) to effect a continued adjustment of the lens assembly position from the one focus range (for example, a normal mode focus range) to a different focus range (for example, a macro mode focus range), while the focus quality determiner (which views a value provided by focus value determiner 18 in the illustrated embodiment) continues to determine the quality of focus of the camera portion of the device. Continuation mechanism 27 may be further provided with a range setting changer to change a focus range setting (i.e., the focus mode) of the camera. In the illustrated embodiment, the range setting is changed from one to the other of the macro and normal modes. This change is made when a final focus position is found during the continued autofocus operation.

The focus value determiner 18 may determine a focus value representative of the quality of focus of the lens assembly on a given target. This may be done in accordance with an active autofocus or a passive autofocus. With an active autofocus, the camera portion may emit a signal that bounces off of the object of the target object being photographed, and the signal, after bouncing back off of the target object, is detected by the camera portion of the device to determine the distance between the device and the target object. In the case of a passive autofocus, an internal computer analysis is carried out (by the focus value determiner 18 in the illustrated embodiment) to determine a focus value, e.g., based upon the contrast of the image.

The lens assembly, to effect changes in focus, is moved from a far end to a near end. The far end is the edge of the normal focus mode, which extents from a moderate location to the far end. The near end is the edge of the macro focus mode. Lens positioning unit 22 includes, among other elements, a lens assembly position sensor and a motor to move the lens assembly to positions ranging from the far end to the near end.

As noted above, the autofocus processor 20 may be provided with both a preliminary operation mechanism 25 to effect an autofocus attempt during a first focus range, and with a continuation mechanism 27 to automatically continue the autofocus of the lens assembly upon a lack of successful focus by the autofocus preliminary operation mechanism 25. The continuation of the autofocus of the lens assembly includes causing the lens positioning adjustment to continue into the other focus range of the lens assembly 12. Specifically, when the camera portion of the device is provided with macro and normal ranges, the continuation of the autofocus moves the focus range from one to the other of the macro and normal ranges.

Generally, in some cameras, an autofocus attempt will occur in only the current focus range. For example, if the camera is set in a macro mode, the autofocus attempt will only occur by testing lens positions within the macro range. If autofocus is now successful, the autofocus search stops. In contrast, in the embodiments illustrated herein, the autofocus will continue by determining if a suitable focus position can be found by moving the lens assembly to the other of the two focus ranges and continuing to determine an appropriate focus position of the lens assembly. The first case may be referred to as a “hard boundary”, wherein the autofocus function will stop and will not continue by moving the lens assembly into the other range. The second case may be referred to as a “soft boundary”, as the autofocus attempt will continue by moving the lens assembly into the other of the two focus ranges, i.e., by moving from one to the other of macro and normal ranges in the illustrated embodiment.

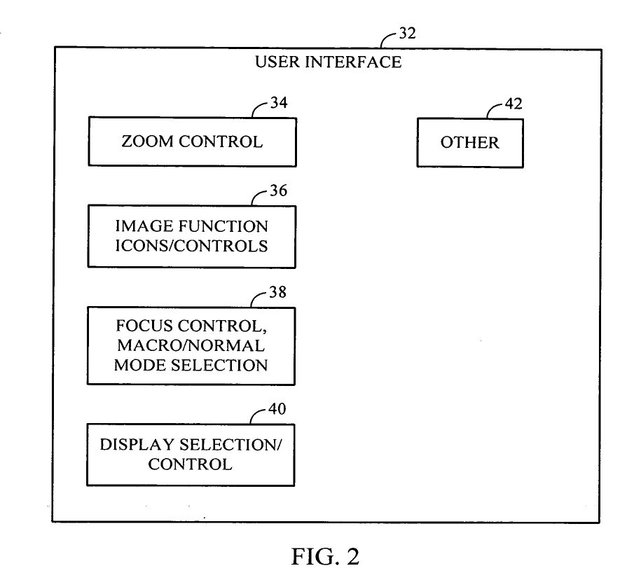

The illustrated embedded device 10 may include a user interface 32 as schematically shown in FIG. 2. The illustrated user interface 32 includes a set of graphical tools, including a zoom control 34 and image function icons or controls 36, focus control and macro and normal mode selection controls 38, and graphical tools for photo and view display selection and control 40. In addition, other selection or control graphical tools 42 may be provided. A graphical tool may include a graphical item such as a button, an icon, a form, or a menu. In addition, or instead, a graphical tool may include a textual command line input. A graphical tool may include a mechanism to allow the input of a switch activation and/or information, and/or to allow the notification or presentation of information to the user. Accordingly, a graphical tool may also include a light, such as an LED indicator, or a symbol and/or textual display communicating information to the user.

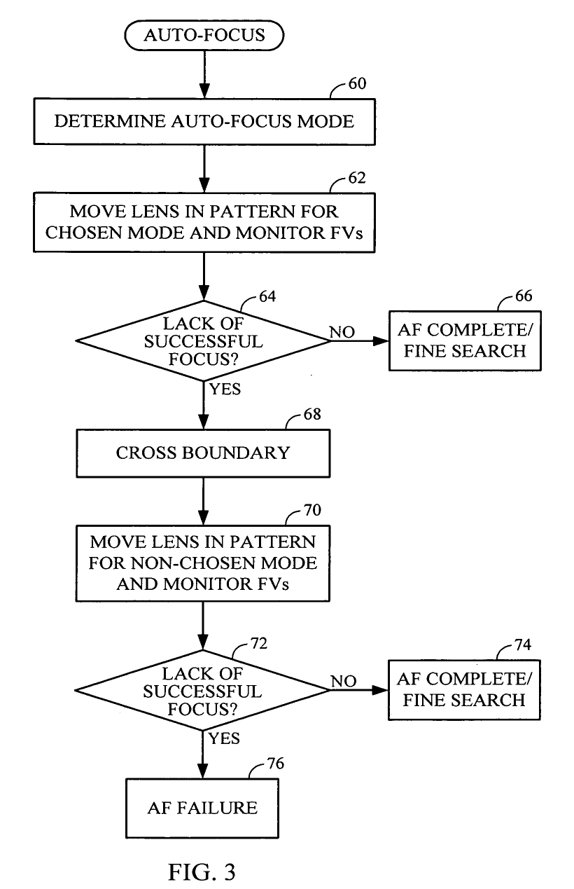

FIG. 3 shows a flow chart of an autofocus process. In a first act 60, a determination is made as to the current autofocus mode of the device. Thereafter, in act 62, the lens is moved in a pattern for the chosen mode, and the focus values are determined throughout the movement of the lens in that pattern. For example, the lens assembly 12 may be in a given position within a particular focus range, for example, the macro range. Before moving the lens assembly 12 and determining the variations of the focus value as a result of those new lens assembly positions, the lens assembly 12 may be moved to a neutral or reference position within the macro range. Alternatively, the lens position may simply remain in its present position somewhere within the macro range, and as it is moved, the focus values may be monitored. The lens assembly 12 is moved in one or more patterns, e.g., throughout all or some of the positions within the current position range for the current autofocus mode, before considering moving the lens assembly to the other of the autofocus ranges. If the autofocus determination within the current range is successful, meaning that a lens position has been selected to focus on a given target object, then the autofocus will be deemed complete.

An embodiment of this process is described as follows, with reference to the acts shown in FIG. 3. Specifically, in act 64, a determination is made, as the lens is moved in the pattern for the current mode, and thus in the current range of movement, as to whether the focus value meets certain criteria, meaning that there has been a lack of a successful focus in the current range of movement. If a successful focus has occurred for that given range of movement of the position lens assembly 12, the autofocus is either deemed to be complete, at act 66, or a fine search algorithm will be performed to refine the positioning of the lens assembly 12 to further refine the focus of the lens assembly 12 on the target object.

If there is a lack of successful focus, as determined at act 64, the process proceeds to act 68, at which point the boundary will be crossed, and the range of lens assembly positions will be changed from the first range (i.e., one of the macro and normal ranges) to the other range (i.e., the other of the macro and normal ranges).

At act 70, the lens is moved in a pattern throughout the second focus range, which corresponds to a focus mode that is not that set for the camera i.e., not chosen by the user. During this movement of the lens in the pattern throughout this other focus range, the focus values are monitored.

At act 72, a determination is made as to whether there is a lack of successful focus along the movement pattern at act 70. If there is a successful focus, the process proceeds to act 74, where the autofocus will be deemed to be complete, or where a fine search algorithm will be started. If there has not been a successful focus, as determined at act 72, the process will proceed to act 76, where the autofocus attempt will be deemed to have failed. At this point, the result of an autofocus failure, may, for example, be that the photographing function of the camera is disabled, and/or the user is notified of the failure of the autofocus, and/or the autofocus function is overwritten to allow the user to manually control the focusing of the lens assembly 12, or move the lens to a position corresponding to the maximum focus value throughout the search (before and after any boundary cross).

In one embodiment, autofocus criteria are considered to determine when an autofocus attempt has been successful for a given range of movement of the lens assembly. For example, three boundary-cross conditions may be considered: criterion A is true when the lens is moving toward the boundary, and the focus value as the lens reaches the boundary is larger than it is elsewhere in the current range of movement. Criterion B is true when all the focus values in the current range are all small, i.e., less than a predefined threshold value. Criterion C is true when the sampled focus values in the current range are “noisy,” e.g., the ratio of the smallest sampled focus value to the largest sampled focus value (FV-min/FV-max) is greater than another threshold value (e.g., 0.75). Using these criteria, in one example implementation of that embodiment, act 64 in the process shown in FIG. 3 would determine that there has been a lack of successful focus if any of A, B, or C is true for the current range of movement. Meanwhile, act 72 would determine that there has been a lack of successful focus if either of A or B is true for the current range of movement (or for the other range of movement before the boundary cross-over).

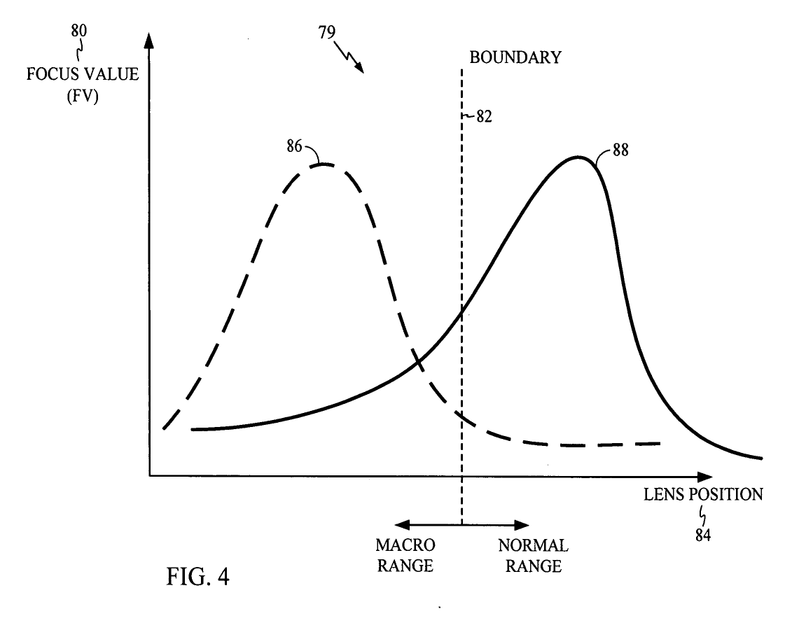

FIG. 4 shows a graph with two focus value curves 86 and 88. The horizontal axis represents the lens position 84. The left portion of the horizontal axis includes a macro range and the right portion includes a normal range. The vertical axis of the graph represents the focus value 80. A first focus value curve 86 is provided which has a peak in the macro range, and a second focus value curve 88 is provided which has a peak in the normal range. The point at which the macro range and the normal range meet may be referred to as the boundary 82, between the macro and normal modes.

The autofocus processor 20 may be provided with one or a plural set of algorithms for performing an autofocus, wherein the boundary between the macro and normal ranges of the lens position is a “soft” boundary, as described above. For example, the algorithm performed may effect a fast searching approach for searching for the focus position, with less of a concern for the manner in which the lens movement is stopped as it nears or arrives at the target position. Alternatively, the lens position may be moved at a medium speed, which results in less risk that the target position will be missed, as well as less complications associated with controlling the motor that moves the lens assembly. A slower, more exhaustive focus search algorithm may be employed as well.

The claims as originally presented, and as they may be amended, encompass variations, alternatives, modifications, improvements, equivalents, and substantial equivalents of the embodiments and teachings disclosed herein, including those that are presently unforeseen or unappreciated, and that, for example, may arise from applicants/patentees and others.

What is claimed is:

1. Apparatus comprising:
an autofocus mechanism including an autofocus preliminary operation mechanism to start an autofocus of a lens assembly on a given target by causing a focus quality determiner to determine the quality of focus of the lens assembly on the given target while the position of the lens unit is in one focus range, and by causing an adjustment controller to effect a preliminary adjustment of the lens assembly position within the same one focus range; and
the autofocus mechanism furthering including an autofocus continuation mechanism to automatically, upon a lack of successful focus by the autofocus preliminary operation mechanism, continue an autofocus of the lens assembly on the given target by causing the adjustment controller to effect a continued adjustment of the lens assembly position from the one focus range to a different focus range while the focus quality determiner continues to determine the quality of the focus.

2. The apparatus according to claim 1, wherein the apparatus comprises an embedded device.

3. The apparatus according to claim 2, wherein the apparatus comprises a mobile communications device.

4. The apparatus according to claim 2, wherein the apparatus comprises a mobile phone and a camera.

5. The apparatus according to claim 1, wherein the apparatus comprises a camera.

6. The apparatus according to claim 5, wherein the apparatus further comprises a lens positioning unit.

7. The apparatus according to claim 6, wherein the lens positioning unit includes a motor to move a lens assembly to positions ranging from a far end to a near end.

8. The apparatus according to claim 7, wherein the far end is an edge of a normal focus mode, and wherein the near end is an edge of a macro focus mode.

9. The apparatus according to claim 8, wherein the lens positioning unit further includes a lens assembly position sensor.

10. The apparatus according to claim 6, further comprising a focus unit to adjust the lens assembly positioning to obtain a desired focus, the focus unit including the autofocus mechanism.

11. The apparatus according to claim 1, wherein the autofocus mechanism includes a focus quality determiner to determine a quality of focus of the lens assembly on a given target, and includes an adjustment controller to interact with a lens positioning unit to effect adjustment of the positioning of the lens assembly towards an improved quality of focus of the lens assembly on the given target.

12. The apparatus according to claim 1, wherein the autofocus preliminary operation mechanism causes an adjustment controller to effect a preliminary adjustment of the lens assembly position while leaving the lens assembly position within the present focus range.

13. The apparatus according to claim 1, wherein the preliminary operation mechanism causes the adjustment controller to effect a preliminary adjustment of the lens assembly position, including first moving the lens assembly position to a reference position or a home position, or first starting the lens assembly position from its present unmodified position.

14. The apparatus according to claim 1, wherein the preliminary adjustment of the lens assembly position includes coarse position adjustment increments.

15. The apparatus according to claim 1, wherein the preliminary adjustment of the lens assembly position includes coarse adjustment of the lens assembly position in coarse increments and later fine adjustment of the lens assembly position in smaller increments.

16. The apparatus according to claim 1, wherein the preliminary adjustment of the lens assembly position includes a final adjustment of the lens assembly position resulting in a successful focus when the one focus range is the correct focus range.

17. The apparatus according to claim 1, wherein the one focus range includes one of a macro range and a normal range, and wherein the different focus range includes the other of the macro and the normal range.

18. The apparatus according to claim 17, further comprising a range setting changer to change a focus range setting of the camera from one to the other of the macro and normal ranges when a final focus position is found during the continued autofocus operation.

19. A method comprising:
performing an autofocus preliminary operation to start an autofocus of a lens assembly on a given target, the autofocus preliminary operation including causing a focus quality determiner to determine the quality of focus of the lens assembly on the given target while the position of the lens unit is one focus range and causing an adjustment controller to effect a preliminary adjustment of the lens assembly position within the same one focus range; and
performing an autofocus continuation to automatically, upon a lack of successful focus by the autofocus preliminary operation, continue an autofocus of the lens assembly on the given target by causing the adjustment controller to effect a continued adjustment of the lens assembly position from the one focus range to a different focus range while the focus quality determiner continues to determine the quality of the focus.

20. The method according to claim 19, wherein the one focus range includes one of the macro range and the normal range, and wherein the different focus range includes the other of the macro and the normal range.

21. The method according to claim 20, further comprising performing a range setting to change a focus range setting of a camera from one to the other of the macro and normal ranges when a final focus position is found during the continued autofocus operation.

22. An integrated circuit comprising:
an autofocus preliminary operation mechanism to start an autofocus of a lens assembly on a given target by signaling a focus quality determiner to determine the quality of focus of the lens assembly on the given target while the position of the lens unit is one focus range and by signaling an adjustment controller to effect a preliminary adjustment of the lens assembly position within the same one focus range; and
an autofocus continuation mechanism to automatically, upon receipt of a signal indicating a lack of successful focus by the autofocus preliminary operation mechanism, continue an autofocus of the lens assembly on the given target by signaling the adjustment controller to effect a continued adjustment of the lens assembly position from the one focus range to a different focus range while the focus quality determiner continues to determine the quality of the focus.

23. The integrated circuit according to claim 22, wherein the one focus range includes one of the macro range and the normal range, and wherein the different focus range includes the other of the macro range and the normal range.

24. The integrated circuit according to claim 23, further comprising a range setting changer to change a focus range setting of a camera from one to the other of the macro range and the normal range when a final focus position is found during the continued autofocus operation.

25. Machine-readable media encoded with data, the encoded data being interoperable with a machine to cause:
performing an autofocus preliminary operation to start an autofocus of a lens assembly on a given target by causing a focus quality determiner to determine the quality of focus of the lens assembly on the given target while the position of the lens unit is in one focus range and causing an adjustment controller to effect a preliminary adjustment of the lens assembly position within the same one focus range; and
performing an autofocus continuation to automatically, upon a lack of successful focus by the autofocus preliminary operation, continue an autofocus of the lens assembly on the given target by causing the adjustment controller to effect a continued adjustment of the lens assembly position from the one focus range to a different focus range while the focus quality determiner continues to determine the quality of the focus.

26. The machine-readable media according to claim 25, wherein the data is encoded to be interoperable with a machine to cause the one focus range to include one of a macro range of a camera and a normal range of a camera, and to cause the different focus range to be the other of the macro range and the normal range.

27. The machine-readable media according to claim 26, wherein the encoded data is interoperable with a machine to cause a range setting changer to change a focus range setting of a camera from one to the other of the macro range and the normal range when a final focus position is found during the continued autofocus operation.

28. Apparatus comprising:
first means for starting an autofocus of a lens assembly on a given target by causing a focus quality determiner to determine the quality of focus of the lens assembly on the given target while the position of the lens unit is in one focus range, and by causing an adjustment controller to effect a preliminary adjustment of the lens assembly position, within the same one focus range; and
second means for automatically, upon a lack of successful focus by the first means, continuing an autofocus of the lens assembly on the given target by causing the adjustment controller to effect a continued adjustment of the lens assembly position from the one focus range to a different focus range while the focus quality determiner continues to determine the quality of the focus.

29. The apparatus according to claim 28, wherein the one focus range includes one of a macro range and a normal range, and wherein the different focus range includes the other of the macro and the normal range.

30. The apparatus according to claim 29, further comprising a range setting changer to change a focus range setting of a camera from one to the other of the macro and normal ranges when a final focus position is found during the continued autofocus.
